(19) United States
(12) Patent Application Publication
(10) Pub. No.: US 2009/0284352 A1
(43) Pub. Date: Nov. 19, 2009

(54) TRANSPONDER, READER, METHOD OF OPERATING A TRANSPONDER, AND METHOD OF OPERATING A READER

(75) Inventors: Harald Witschnig, Gratkorn (AT); Michael Gebhart, Linz (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/514,746

(22) PCT Filed: Nov. 13, 2007
(86) PCT No.: PCT/IB2007/054606

§ 371 Date: May 13, 2009

(30) Foreign Application Priority Data
Nov. 14, 2006 (EP) 06023643.7

(51) Int. Cl. H04Q 5/22

(52) U.S. Cl. 340/10.1

(57) ABSTRACT

In a method of operating a transponder (1, 51) a parallel digital data stream comprised of a plurality of digital data sequences (23-25) is generated by the transponder (1, 51). Then, a plurality of modulated signals (42-44) by modulating each of the digital data sequences (23-25) with a dedicated carrier/subcarrier of a plurality of carriers/subcarriers (26-28) is generated. The modulated signals (42-44) are orthogonal to each other.

### FIELD OF THE INVENTION

The invention relates to a transponder, to a reader, to a method of operating a transponder, and to a method of operating a reader.

### BACKGROUND OF THE INVENTION

As it is disclosed in Klaus Finkenzeller, “RFID-Handbuch, Grundlagen und praktische Anwendungen induktiver Funkanlagen, Transponder und kontaktloser Chipkarten”, 3^{rd} edition, Hanser, Munich, 2002, one common method to transmit data from an RFID transponder to a reader is load modulation. A transponder is also called a tag or a label, the reader is also known as a base station, and load modulation is a special form of amplitude modulation. When being close to the reader, then the transponder is inductively coupled to the reader. The reader transmits data utilizing a magnetic field and the transponder represents a load for the reader. The transponder responds by adjusting its load impedance by, for instance, adjusting its load resistance or its capacitance. In turn, the transformed impedance at the reader is varied, resulting in a varying voltage across the antenna of the reader. By doing so, data is sent from the transponder to the reader by means of load modulation.

In order to improve the performance of load modulation, the aforementioned publication discloses the use of modulation in combination with a subcarrier. In this case, the data to be transmitted from the transponder to the reader is modulated with the subcarrier using, for instance, Phase-Shift-Keying (PSK), Amplitude-Shift-Keying (ASK), or Frequency-Shift-Keying (FSK).

U.S. Pat. No. 6,745,008 B1 furthermore discloses a multi-frequency communication system that includes a reader and a plurality of RFID tags. The tags are configured to receive a first signal from the reader and to generate and send a second signal to the reader in response to the received first signal. The second signal comprises first and second modulation components. The first modulation component consists of a low-level frequency digital code. The second frequency component contains data associated with the relevant tag enabling the reader to distinguish two tags and to associate the unique data retrieved from the data signal embedded in the second frequency components with the correct tag. By enabling a single tag to modulate at two or more intermediate frequencies, the data stored in the tag can be transmitted at a higher data rate. Modulating at plural intermediate frequencies allows the data to be transmitted in parallel rather than the serial fashion.

### OBJECT AND SUMMARY OF THE INVENTION

It is an object of the present invention to provide an RFID transponder which provides a precondition to transmit data with relative high data rate, wherein the transmission of the data is less prone to interference.

It is another object of the present invention to provide a reader for an RFID transponder which provides a precondition to transmit data with a relative high data rate, wherein the transmission of the data is less prone to interference.

Further objects of the present invention are to provide corresponding methods of operating an RFID transponder or a reader.

The object is achieved in accordance with the invention by means of a transponder, comprising:

a device for generating a parallel digital data stream comprised of a plurality of digital data sequences; and

a device for generating a plurality of modulated signals by modulating each of the digital data sequences with a dedicated carrier/subcarrier of a plurality of carriers/subcarriers, wherein the modulated signals are orthogonal to each other.

The purpose of an RFID transponder is to transmit data to a reader, particularly in response to a query received from the reader. The data may be stored in a memory of the transponder and has to be transmitted utilizing an antenna of the transponder. For transmitting the data, the data is usually read out from the memory as a serial digital data stream. Conventional transponders transmit this serial data stream usually utilizing load modulation in a serial fashion. The inventive transponder, however, includes the device for generating the parallel digital data stream. The parallel digital data stream comprises the at least two digital data sequences. Thus, the inventive transponder is capable to provide the data to be transmitted to the reader as a parallel data stream.

The inventive transponder furthermore comprises a device for generating the plurality of modulated signals. This device modulates each data sequence of the parallel data stream with a dedicated subcarrier. The modulated signals are particularly meant for the transmission of the data to the reader. Since the data are available as the parallel data stream, the modulated signals are also available as a parallel data stream to be transmitted in parallel. Thus, data can be transmitted with a higher data rate than data of a serial data stream modulated with one subcarrier.

The individual subcarrier frequencies of the subcarriers are chosen in a way that the modulated signals are orthogonal to each other. The modulated signals are orthogonal to each other, if the subcarrier frequencies (except the one with the lowest frequency) are an harmonics of the subcarrier frequency with the lowest frequency. Since the modulated signals are orthogonal to each other, they are less prone to mutual interference resulting in a more robust transmission of the parallel data stream modulated with the subcarriers.

The parallel data stream may particularly be a digital data stream and the subcarriers may be pulse shaped. This is advantageous because pulse shaped signals are easy to generate.

The device for generating the parallel digital data stream may be a device for converting a serial data stream into the parallel data stream. The data to be transmitted to the reader may be read out from the transponder memory as a serial data stream. The device for converting a serial data stream into the parallel data stream can convert this serial data stream into the parallel data stream comprised of the plurality of data sequences. The device for converting a serial data stream into the parallel data stream may be realized as a serial in parallel out shift register.

The inventive transponder may also be designed such that the data stored in the memory can be read out as a parallel data stream. This can be achieved, for instance, by a plurality of memories which are read out simultaneously such that the data sequences originate from its related memory.

The inventive transponder may particularly transmit the data utilizing load modulation. Load modulation is principally known to the skilled person from, for instance, Klaus Finkenzeller, “RFID-Handbuch, Grundlagen und praktische Anwendungen induktiver Funkanlagen, Transponder und kontaktloser Chipkarten”, 3^{rd} edition, Hanser, Munich, 2002. In order to perform load modulation, the transponder comprises a load modulator. A load modulator is, for instance, a switch and a load resistor or capacitor connected in series. The load modulator and the antenna of the transponder may be connected in parallel. Load modulation is achieved when the transponder responds to a received signal by adjusting its load impedance by, for instance, opening and closing the switch of the load modulator in order to adjust the load impedance of the transponder.

In one embodiment, the inventive transponder comprises a plurality of load modulators, each controlled by a dedicated modulated signal of the plurality of modulated signals. The antenna and the load modulators may then be connected in parallel. For this variant of the inventive transponder, each load modulator is controlled by an individual of the modulated signals. The load modulators are operated in parallel, i.e. at the same time. Therefore, the resulting load modulated signal transmitted by the antenna corresponds to the sum of the individual modulated signals.

In a further embodiment, the inventive transponder comprises a combining device for generating a resulting modulated signal by combining the plurality of modulated signals.

The combining device may be a summation device which generates the resulting modulated signal by adding the modulated signals. If the inventive transponder comprises the plurality of load modulators, then the resulting modulated signal can be utilized to control the plurality of load modulators instead of controlling the load modulators by the individual modulated signals.

In one embodiment of the inventive transponder, the modulated signals are digital signals. Then, the combining device may particularly be configured to generate the resulting modulated signal by performing an OR disjunction of the modulated signals. This variant of the inventive transponder is particularly advantageous if the inventive transponder comprises only a single load modulator which is controlled by the resulting modulated signal, as it is the case for one embodiment of the inventive transponder. This variant of the inventive transponder has the advantage that only one load modulator is needed, thus simplifying the design of the transponder. The OR disjunction may be obtained utilizing an OR gate as the combining device. The OR disjunction may also be obtained by adding the modulating signals utilizing, for instance, the summing device, and then limiting the output signal of the summing device such that the resulting signal is a digital signal.

If the inventive transponder comprises the antenna and the single load modulator connected in parallel and each of the modulated signals is a digital signal having first and second states, then the inventive transponder may be configured to activate the single load modulator if at least one of the modulated signals has its first state and to deactivate the single load modulator, if all modulated signals have their second states. Alternatively, the inventive transponder according to this embodiment can be configured to deactivate the single load modulator if at least one of the modulated signals has its first state and to activate the single load modulator if all modulated signals have their second states. For this embodiment, the control of the single load modulator is affected as if it is controlled by a signal obtained by a logical OR combination of the modulated signals.

The signal transmitted by the inventive transponder may thus be based on the modulated signals. Since these signals are available in parallel and are orthogonal to each other, faster transmission of the data from the transponder to the reader can be achieved. Additionally, since the modulated signals are orthogonal to each other, they, at least theoretically, do not interfere with each other. Thus, the transponder can receive the transmitted signals and retrieve the transmitted data from the received signal by detecting the amplitude values at the underlying frequencies of the subcarrier frequencies.

The object is also achieved in accordance with the invention by means of a reader for a transponder, comprising:

a device for generating a parallel digital data stream comprised of a plurality of digital data sequences; and

a device for generating a plurality of modulated signals by modulating each of the digital data sequences with a dedicated carrier/subcarrier of a plurality of carriers/subcarriers, wherein the modulated signals are orthogonal to each other.

With such a reader, data can be written faster into a transponder.

The modulated signals may be digital signals and the inventive reader may comprise a device for generating a resulting modulated signal by combining the plurality of modulated signals such that the resulting modulated signal is an OR disjunction of the modulated signals.

Generally, the invention provides in one aspect an electric circuit for a reader or a transponder, which circuit generates a plurality of modulated signals by modulating a parallel digital data stream with a plurality of subcarriers, wherein the modulated signals are orthogonal to each other. The circuit preferably generates a resulting modulated signal by combining the modulated signals in an OR disjunction fashion. If used for the transponder, then the circuit is meant to be connected to an antenna. Then, the circuit may comprise the single load modulator which is controlled as described for the relevant embodiments of the inventive transponder. The circuit, however, may alternatively comprise the plurality of load modulators which are controlled as described for the relevant embodiments of the inventive transponder.

The object of the invention is also achieved in accordance with the invention by means of a method of operating a transponder, comprising the steps of:

generating a parallel digital data stream comprised of a plurality of digital data sequences with a transponder; and

generating a plurality of modulated signals by modulating each of the digital data sequences with a dedicated carrier/subcarrier of a plurality of carriers/subcarriers, wherein the modulated signals are orthogonal to each other.

The inventive method of operating a transponder can be carried out by the inventive transponder.

The inventive method may further comprise the step of controlling each of a plurality of load modulators of the transponder by a dedicated modulated signal of the plurality of modulated signals, wherein the load modulators and an antenna of the transponder are connected in parallel.

The inventive method may also comprise the step of generating a resulting modulated signal by combining the plurality of modulated signals.

The inventive method may furthermore comprise the steps of generating a resulting modulated signal by adding the modulated signals and controlling a plurality of load modulators of the transponder utilizing the resulting modulated signal, wherein the load modulators and an antenna of the transponder are connected in parallel.

If the modulated signals are digital signals, then the inventive method may further comprise the step of generating a resulting modulated signal by combining the plurality of modulated signals in an OR disjunction manner.

The resulting modulated signal may be used to control a single load modulator of the transponder. The single load modulator and the antenna of the transponder may be connected in parallel.

If each modulated signal is a digital signal having first and second states and the transponder comprises a single load modulator, then the following further steps may be carried out: activating the single load modulator if at least one of the modulated signals has its first state and deactivating the single load modulator if all modulated signals have their second states.

Alternatively, the following further steps may be carried out: deactivating the single load modulator if at least one of the modulated signals has its first state and activating the single load modulator if all modulated signals have their second states.

The parallel digital data stream may be generated by converting a serial data stream into the parallel data stream.

The object of the invention is also achieved in accordance with the invention by means of a method of operating a reader that can communicate with a transponder, comprising the steps of:

generating a parallel digital data stream comprised of a plurality of digital data sequences; and

generating a plurality of modulated signals by modulating each of the digital data sequences with a dedicated carrier/subcarrier of a plurality of carriers/subcarriers, wherein the modulated signals are orthogonal to each other.

The modulated signals may be digital signals and the inventive method may further comprise the step of generating a resulting modulated signal by combining the plurality of modulated signals in an OR disjunction manner.

It should be noted that the embodiments which are presented herein with respect to transponders in principle are also applicable to readers.

It should also be noted that the inventive concept works for both modulating data sequences with a carrier or a subcarrier. Hence, the term “carrier/subcarrier” is used in the claims. However, as modulating with a subcarrier is more widespread than modulating just with carriers, simply the term “subcarrier” is used herein for the sake of brevity, nevertheless including “carrier” semantically. To make clear what is meant and why the invention equally applies to carriers and subcarriers, some examples of radio systems are made, which work in a slightly different way.

1) A reader may transmit data by modulating it with a single carrier, e.g. a 13.56 MHz carrier as it is used for RFID systems according to ISO 14443. Then, the transponder may answer by use of a plurality of subcarriers, which are arranged around the 13.56 MHz carrier in the frequency domain, according to the invention.

2) The reader may also use a plurality of subcarriers (e.g. again arranged around the 13.56 MHz carrier) to transmit data. In this case, a transponder can answer by using said plurality of subcarriers emitted by the reader. By doing so, data can be transmitted very effectively in both directions because of the splitting of the data streams.

3) In a similar way, a reader simply may use a plurality of carriers, e.g. 500 kHz, 1 MHz, 1.5 MHz, etc., to transmit data. Similarly, a transponder can answer by use of said plurality of carriers emitted by the reader. Again, data can be transmitted very effectively in both directions because of the splitting of the data streams. However, this embodiment is possibly not the most useful one as there might be heavy interferences between different radio systems all working in the base band as it is well known. Nevertheless, this embodiment may be used particularly for isolated applications.

### BRIEF DESCRIPTION OF THE DRAWINGS

The invention will be described in greater detail hereinafter, by way of non-limiting examples, with reference to the embodiments shown in the drawings.

FIG. 1 is an RFID transponder and a reader;

FIG. 2 is a block diagram of a first exemplary embodiment of the transponder of FIG. 1;

FIG. 3 is a block diagram of a second exemplary embodiment of the transponder of FIG. 1;

FIG. 4 are signals generated by the embodiment shown in FIG. 3;

FIG. 5 is a further RFID transponder;

FIG. 6 is a block diagram of one exemplary embodiment of the transponder of FIG. 5;

FIG. 7 are signals generated by the embodiment shown in FIG. 6; and

FIG. 8 a reader.

### DESCRIPTION OF EMBODIMENTS

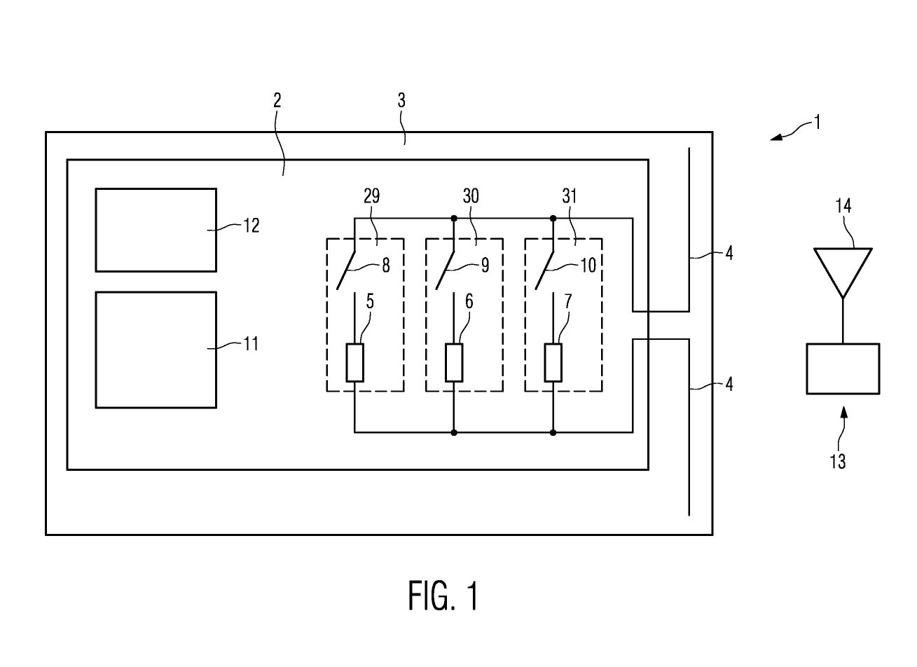

FIG. 1 shows an RFID transponder 1, which comprises an integrated circuit 2 attached to a substrate 3 and an antenna 4 connected to the integrated circuit 2. The substrate 3 is, for instance, a plastic foil or a sheet of paper. In this embodiment, the antenna 4 is attached to the substrate 3. The integrated circuit 2, however, can also be attached to a further substrate which is usually called a strap.

In this embodiment, the transponder 1 is a passive transponder and communicates with a well known reader 13. The reader 13 sends signals to the transponder 1 and the transponder 1 responds to these signals. Since the transponder 1 is a passive transponder in this embodiment, the transponder 1 is powered by the electromagnetic field transmitted from a reader antenna 14 of the reader 13 in a well known manner.

The integrated circuit 2 comprises a microprocessor 11, a memory 12, first, second, and third load resistors 5-7, and first, second, and third switches 8-10. The first switch 8 and the first load resistor 5 are connected in series. If the first switch 8 is closed, then the first load resistor 5 and the antenna 4 are connected in parallel. The second switch 9 and the second load resistor 6 are connected in series. If the second switch 9 is closed, then the second load resistor 6 and the antenna 4 are connected in parallel. The third switch 10 and the third load resistor 7 are connected in series. If the third switch 10 is closed, then the third load resistor 7 and the antenna 4 are connected in parallel.

The microprocessor 11 is configured to open and close the switches 8-10 so that the corresponding load resistors 5-7 and the antenna 4 are connected in parallel. By opening and closing the switches 5-8, load modulation is achieved. Utilizing load modulation, the transponder 1 can send data to the reader 13 in response to the received signal. Thus, the combination of the first switch 8 and the first load resistor 5 form a first load modulator 29, the combination of the second switch 9 and the second load resistor 6 form a second load modulator 30, and the combination of the third switch 7 and the third load resistor 10 form a third load modulator 31.

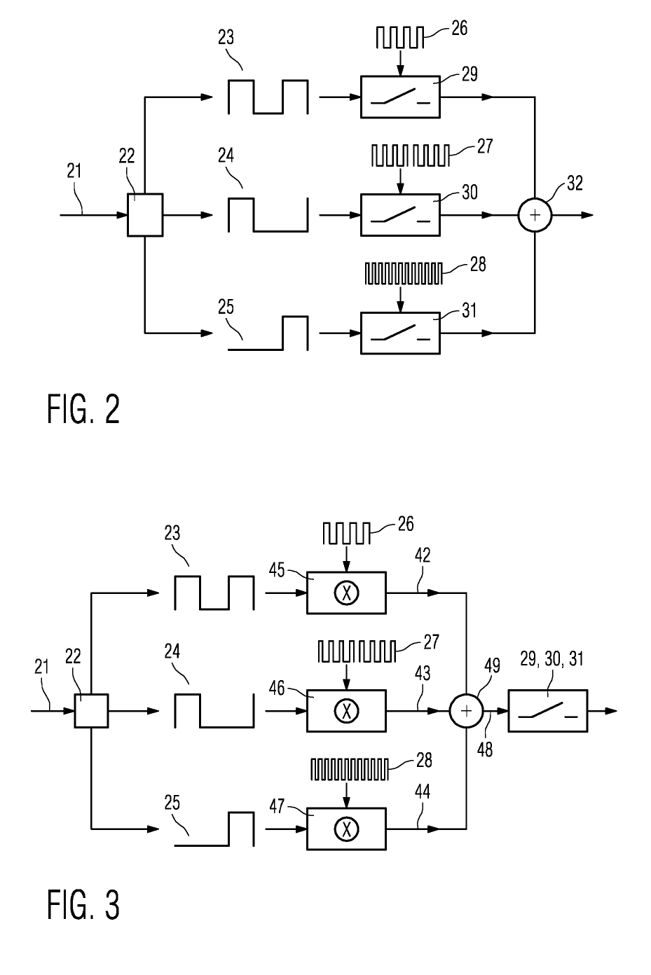

Two further embodiments of controlling the switches 8-10 are described hereinafter. The first embodiment is depicted in FIG. 2 and the second embodiment in FIG. 3.

In response to the received signal, the transponder 1 generates a digital serial data stream 21. The serial data stream 21 is read out from the memory 12 by the microprocessor 11 in response to the received signal.

The serial data stream 21 is fed to a serial to parallel conversion block 22, which converts the serial data stream 21 to a parallel data stream having first, second, and third data sequences 23-25. For the exemplary embodiments, the functional block 22 may be implemented as a serial in parallel out shift register and may be realized by the microprocessor 11.

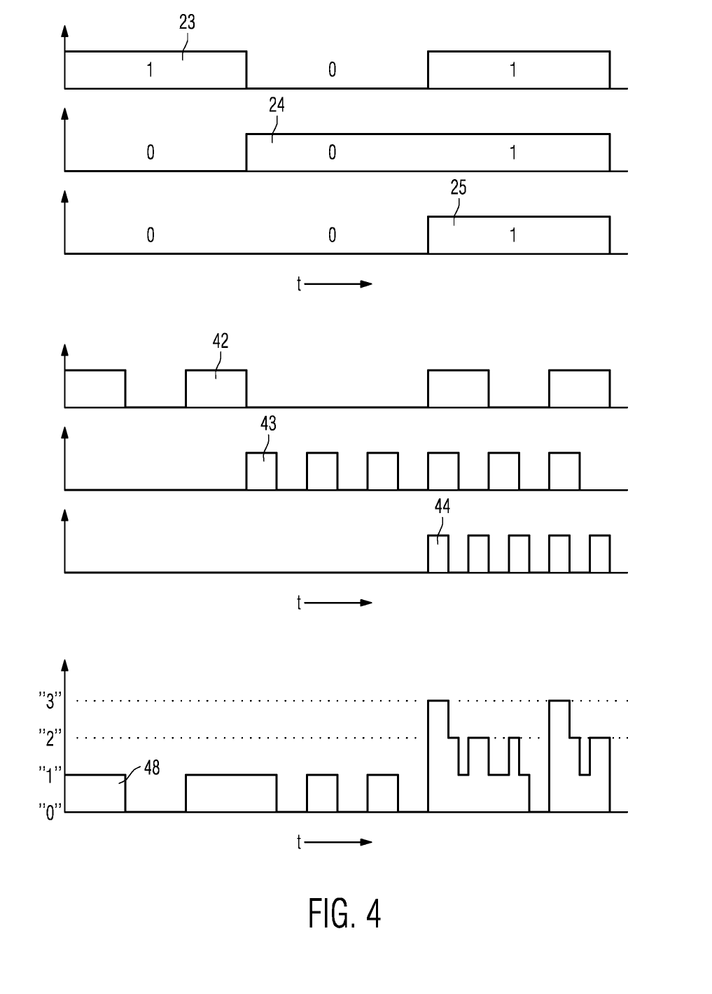

For the embodiment shown in FIG. 2, the first data sequence 23 is modulated with a first subcarrier 26 having a first subcarrier frequencies f₁ in order to generate a first modulated signal 42 shown in FIG. 4, the second data sequence 24 is modulated with a second subcarrier 27 having a second subcarrier frequencies f₂ in order to generate a second modulated signal 43, and the third data sequence 25 is modulated with a third subcarrier 28 having a third subcarrier frequencies f₃ in order to generate a third modulated signal 44. The modulation of the data sequences 23-25 is carried out in parallel and the subcarrier frequencies f₁, f₂, f₃ are chosen such that the resulting first, second, and third modulated signals 42-44 are orthogonal to each other. For the exemplary embodiment, this is achieved by the following conditions:
each of the subcarrier frequencies f₁, f₂, f₃ differs from each other and
two of the three subcarrier frequencies f₂, f₃ are harmonics of the remaining subcarrier frequency f₁.

For the exemplary embodiment of FIG. 2, the subcarrier frequencies f₁, f₂, f₃ are particularly chosen such that

f₂=2f₁

f₃=3f₁

Additionally, the subcarrier signals 26-28 are pulse shaped so that the modulated signals 42-44 are also pulse shaped.

In the embodiment of FIG. 2, the modulated signals are used to control the switches 8-10 directly. Particularly, the first modulated signal 42 is used to control the first switch 8, the second modulated signal 43 is used to control the second switch 9, and the third modulated signal 44 is used to control the third switch 10. In this embodiment, the respective switch 8-10 is closed if the relevant modulated signal is logical “high” and is open if the relevant modulated signal is logical “low”. Thus, each load modulator 29-31 is controlled by the relevant modulated signal 42-44.

The load resistors 5-7 including their relevant switches 8-10 and the antenna 4 are connected in parallel. The closing and opening of the switches 8-10 causes the changing load impedance, which the transponder 1 represents to the reader 13 and which in turn results in a corresponding change of the voltage across the reader antenna 14. Since the data sequences 23-25 are modulated in parallel, the resulting change in the voltage across the reader antenna 14 corresponds to a summation of the three modulated signals 42-44. This is indicated by the “plus” symbol 32 of FIG. 2.

The changing voltage across the reader antenna 14 is the signal which the reader 13 receives. By analyzing this signal in the frequency domain by detecting the amplitude value at the underlying frequency, the reader 13 can retrieve the information of the digital serial data stream 21.

The main difference between the embodiments of FIGS. 2 and 3 is the method to realize the load modulation. In contrast to controlling the switches 8-10 utilizing the individual modulated signals 42-44, the three modulated signals 42-44 of the embodiment of FIG. 3 are used to generate a resulting modulated signal 48 which is used to control the switches 8-10.

As for the first exemplary embodiment of FIG. 2, the data sequences 23-25 are modulated with the subcarrier signals 26-28 in order to generate first, second, and third modulated signals 42-44 which are orthogonal to each other. The generation of the modulated signals 42-44 is carried out by first, second, and third modulators 45-47 which may be incorporated in the microprocessor 11. The modulators 45-47 are based on On-Off Keying (OOK) for the exemplary embodiment. Other suitable modulation techniques include, without restriction, Phase-Shift-Keying (PSK), Amplitude-Shift-Keying (ASK), and Frequency-Shift-Keying (FSK).

The modulated signals 42-43 are generated in parallel and are combined to a single resulting modulated signal 48 by adding the individual modulated signals 42-43 utilizing a summation functional block 49.

FIG. 4 shows an example of the three data sequences 23-25, the corresponding modulated signals 42-44, and the resulting modulated signal 48 (it should be noted that the resulting modulated signal 48 in principle is the same as the voltage across the reader antenna 14 of FIG. 2).

As it is evident from FIG. 4, the resulting modulated signal 48 is not a digital data stream, but can have four states which are the states “0”, “1”, “2”, and “3” for the exemplary embodiment.

The resulting modulated signal 48 is the control signal for the load modulators 29-31, which modulated signal 48 controls the switches 8-10 as following in the exemplary embodiment:

If the resulting modulating signal 48 has the state “0”, then the switches 8-10 are open.

If the resulting modulated signal 48 has the state “1”, then the first switch 8 is closed and the second and third switches 9, 10 are open. Then, only the first load resistor 5 and the antenna 4 are connected in parallel.

If the resulting modulated signal 48 has the state “2”, then the first and second switches 8, 9 are closed and the third switch 10 is open. Then, the first load resistor 5, the second load resistors 6, and the antenna 4 are connected in parallel.

If the resulting modulated signal 48 has the state “3”, then all three switches 8-10 are closed. Then, all three load resistors 5-7 and the antenna 4 are connected in parallel.

Consequently, the voltage across the reader antenna 14 is the same as for the embodiment illustrated in FIG. 2.

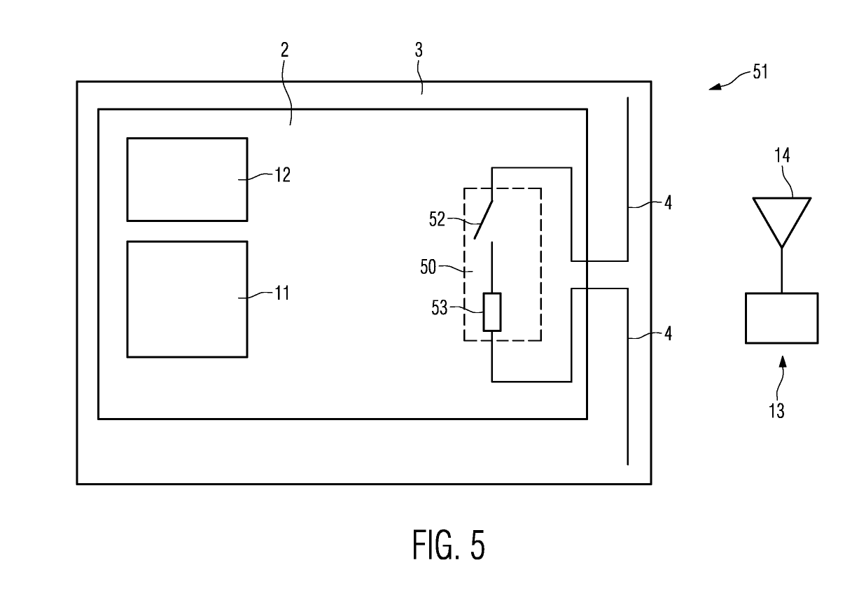

FIG. 5 shows a further transponder 51. If not explicitly mentioned, the parts of the transponder 51 of FIG. 5 which correspond to parts of the transponder 1 of FIG. 1 are denoted with the same reference signs.

The main difference between the transponder 51 and the transponder 1 is that the transponder 51 has only one load resistor 53 and one switch 52, which form a single load modulator 50, instead of the three load resistors 5-8 and the related switches 8-10 of the transponder 1.

In one exemplary embodiment utilizing the transponder 51, the switch 52 is controlled by the resulting modulated signal 48 which is generated, for instance, as described above with reference to FIG. 3. Since the transponder 51 has only one load resistor 53 which can be connected in parallel to the antenna 4 by closing the switch 52, the voltage across the reader antenna 14 can only have two states. In this embodiment, the microprocessor 11 controls the switch 52 such that it is open if the resulting modulated signal 48 has the state “0”. Otherwise, the switch 52 is closed. As a result, the voltage across the reader antenna 14 corresponds to a logical “OR” operation between the three modulated signals 42-44.

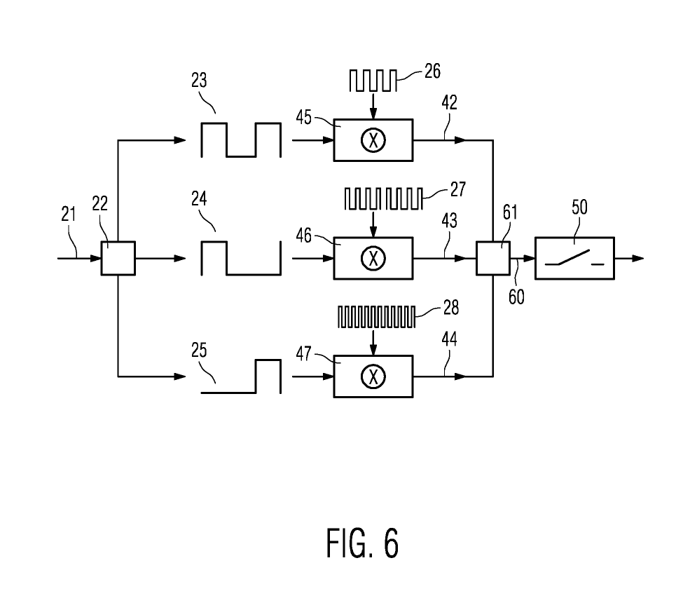

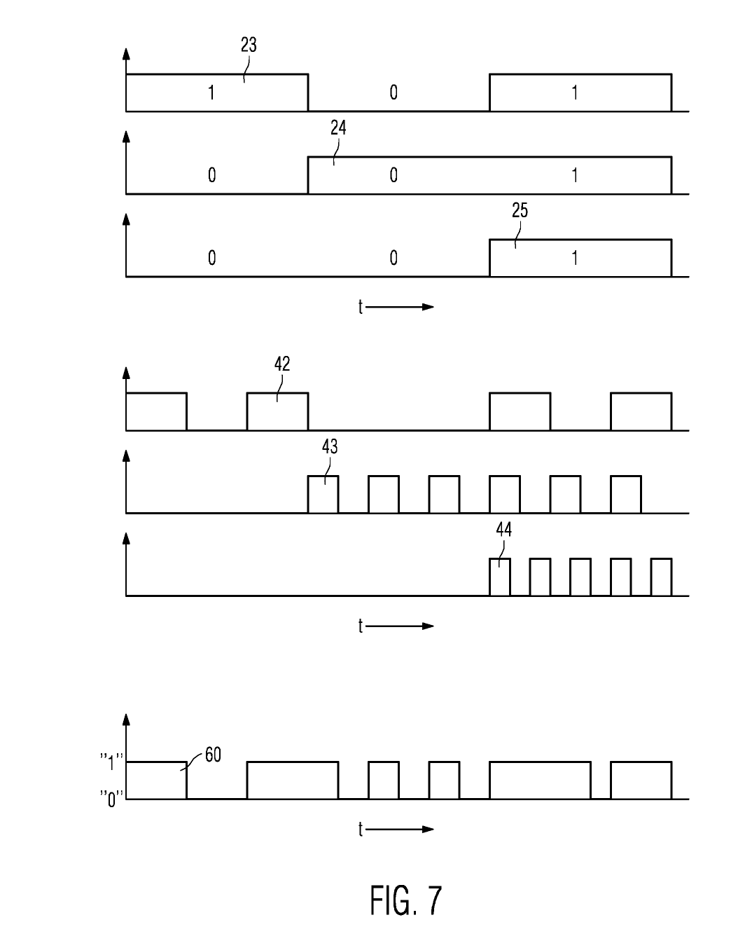

FIG. 6 shows a further embodiment for the transponder 51. The main difference between this embodiment and the embodiment just described before is the generation of the resulting modulated signal, which has the reference sign 60 in FIG. 6. Instead of adding the three modulated signals 42-44 utilizing the summation block 49 of FIG. 3, the resulting modulating signal 60 is generated by combining the three modulated signals 42-44 utilizing an OR functional block 61. The OR functional block 61 may be realized, for instance, by a dedicated OR-gate of the transponder 51, by appropriately configuring the microprocessor 11, or by combining the summation functional block 49 with an amplifier connected downstream of the summation functional block 49, wherein this amplifier saturates such that its output signal is a digital signal. An example of the resulting signal 60 is depicted in FIG. 7.

For this exemplary embodiment, the switch 52 is closed if the resulting modulated signal 60 is logical “high”, and is open if the resulting modulated signal 60 is logical “low.” Surprisingly, though the spikes as shown in the lowest diagram of FIG. 4 are cut away (and thus information is cut away), data, which is transmitted from a transponder to a reader, can be reconstructed in the reader in an unambiguous way.

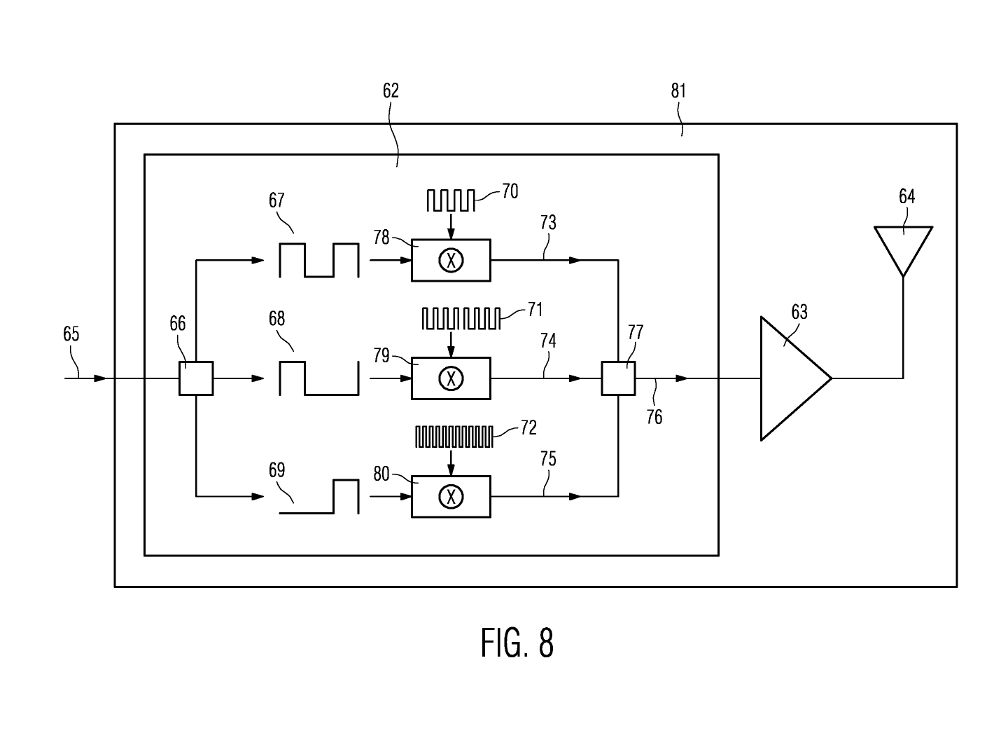

FIG. 8 shows a reader 61 which may be the reader 13 and may be suitable to write data on transponders.

The reader 81 comprises a microprocessor 62, an amplifier 63 for amplifying signals generated by the microprocessor 62, and an antenna 64 driven by the amplifier 63. In this embodiment, the reader 81 is used for writing data on a transponder. The data are fed into the microprocessor 62 in the form of a serial digital data stream 65. The serial data stream 65 is fed to a serial to parallel conversion block 66 which converts the serial data stream 65 to a parallel data stream having first, second, and third data sequences 67-69. For the exemplary embodiments, the functional block 66 may be implemented as a serial in parallel out shift register and is realized by the microprocessor 62.

Then, the first data sequence 67 is modulated with a first subcarrier 70 having a first subcarrier frequencies f₁ in order to generate a first modulated signal 75, the second data sequence 68 is modulated with a second subcarrier 71 having a second subcarrier frequencies f₂ in order to generate a second modulated signal 74, and the third data sequence 69 is modulated with a third subcarrier 72 having a third subcarrier frequencies f₃ in order to generate a third modulated signal 75. The modulation of the data sequences 67-69 is carried out in parallel and the subcarrier frequencies f₁, f₂, f₃ are chosen such that the resulting first, second, and third modulated signals 73-75 are orthogonal to each other. For the exemplary embodiment, this is achieved by choosing the subcarrier frequencies f₁, f₂, f₃ so that the following condition is satisfied:

f₂=2f₁

f₃=3f₁

Additionally, the subcarrier signals 70-72 are pulse shaped so that the modulated signals 73-75 are also pulse shaped.

In this embodiment, the data sequences 67-69 are modulated with the subcarrier signals 70-72 in order to generate first, second, and third modulated signals 73-75 which are orthogonal to each other. The generation of the modulated signals 73-75 is carried out by first, second, and third modulators 78-80. The modulators 78-80 are based on On-Off Keying (OOK) for the exemplary embodiment.

Then the modulated signals 73-75 are used to generate a resulting modulated signal 76 by objecting the modulated signals 73-75 to a logical OR combination, which is indicted as a functional block 77 in FIG. 8. Thus, the resulting modulated signal 76 is generated similar to the resulting modulated signal 60 of FIGS. 6 and 7.

The resulting signal 76 is then fed to the amplifier and transmitted by the antenna 64.

Even though the preferred implementation of the discussed and illustrated methods are for passive transponders (such as the transponders 1, 51, which utilize load modulation), the invention is not restricted to those transponders but only limited by the scope of the claims. Hence, the invention also applies to active transponders and transponders transmitting their data capacitively or electromagnetically. Particularly, also the reader 13 can be configured to transmit a modulated signal which corresponds to the resulting modulated signals 48, 60.

For the embodiments described hereinbefore, three data sequences 23-25, 67-69 are used. This number is only meant as an example. The invention can also be based on two data sequences or on more than three data sequences.

For the embodiments described hereinbefore, the serial data streams 21, 65 furthermore are converted into a parallel data stream. The reader 81 may also be designed such that the parallel data stream is directly input. The transponders 1, 51 can also be designed such that parallel data stream is directly read out from the memory 12.

Finally, it should be noted that the aforementioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The use of the verb “comprise” and its conjugations do not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. A transponder, comprising:
a device for generating a parallel digital data stream comprised of a plurality of digital data sequences; and
a device for generating a plurality of modulated signals by modulating each of the digital data sequences with a dedicated carrier/subcarrier of a plurality of carriers/subcarriers, wherein the modulated signals are orthogonal to each other.

2. The transponder of claim 1, comprising an antenna and a plurality of load modulators; each load modulator being controlled by a dedicated modulated signal of the plurality of modulated signals and the antenna and the load modulators being connected in parallel.

3. The transponder of claim 1, comprising a combining device for generating a resulting modulated signal by combining the plurality of modulated signals.

4. The transponder of claim 3, comprising an antenna and a plurality of load modulators, wherein the combining device is a summation device which generates the resulting modulated by adding the modulated signals (42-44) and the resulting modulated signal (48) controls the plurality of load modulators; the load modulators and the antenna being connected in parallel.

5. The transponder of claim 3, wherein the modulated signals are digital signals and the combining device generates the resulting modulated signal by performing an OR disjunction of the modulated signals.

6. The transponder of claim 5, comprising an antenna and a single load modulator connected in parallel; the resulting modulated signal controlling the single load modulator.

7. The transponder of claim 1, comprising an antenna and a single load modulator connected in parallel, wherein each of the modulated signals is a digital signal having first and second states; the single load modulator being activated if at least one of the modulated signals has its first state and being deactivated if all modulated signals have their second state or the single load modulator being deactivated if at least one of the modulated signals has its first state and being activated if all modulated signals have their second state.

8. The transponder of claim 1, wherein the device for generating a parallel digital data stream is a device for converting a serial data stream into the parallel data stream.

9. A reader for a transponder, comprising:
a device for generating a parallel digital data stream comprised of a plurality of digital data sequences; and
a device for generating a plurality of modulated signals by modulating each of the digital data sequences with a dedicated carrier/subcarrier of a plurality of carriers/subcarriers, wherein the modulated signals are orthogonal to each other.

10. The reader of claim 9, wherein the modulated signals are digital signals; the reader comprising a device for generating a resulting modulated signal by combining the plurality of modulated signals such that the resulting modulated signal is an OR disjunction of the modulated signals.

11. A method of operating a transponder, comprising the steps of:
generating a parallel digital data stream comprised of a plurality of digital data sequences with a transponder; and
generating a plurality of modulated signals by modulating each of the digital data sequences with a dedicated carrier/subcarrier of a plurality of carriers/subcarriers, wherein the modulated signals are orthogonal to each other.

12. A method of operating a reader that can communicate with a transponder, comprising the steps of:
generating a parallel digital data stream comprised of a plurality of digital data sequences; and
generating a plurality of modulated signals by modulating each of the digital data sequences with a dedicated carrier/subcarrier of a plurality of carriers/subcarriers, wherein the modulated signals are orthogonal to each other.
